(19) United States
(12) Patent Application Publication
(10) Pub. No.: US 2026/0321835 A1
(43) Pub. Date: Oct. 15, 2026

(54) APPARATUS FOR CUTTING A BATTERY CELL CAN

(71) Applicant: GM Global Technology Operations LLC, Detroit, MI (US)

(72) Inventors: Daniel Ryan, Fenton, MI (US); Andrew Clay Bobel, Troy, MI (US); Jennifer Therese Bracey, Holly, MI (US)

(73) Assignee: GM Global Technology Operations LLC, Detroit, MI (US)

(21) Appl. No.: 19/179,671

(22) Filed: Apr. 15, 2025

(51) Int. Cl. H01M 50/233; H01M 10/42; H01M 10/54; H01M 50/209; H01M 50/249

(52) U.S. Cl. CPC H01M 50/233; H01M 50/209; H01M 10/4285; H01M 10/54; H01M 50/249

(57) ABSTRACT

An apparatus for cutting a prismatic battery cell can including a base, a fixture coupled to the base for orienting the prismatic battery cell can, and a cutting device. The cutting device includes one or more guide rails coupled to the base, a retainer coupled to the one or more guide rails and movable with respect to a first axis, a tool guide coupled to the base, and one or more cutting tools coupled to the retainer and to the tool guide, the one or more cutting tools being movable with respect to the first axis and a second axis that is perpendicular to the first axis.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to battery cells and, more particularly, an apparatus for cutting a battery cell.

Prismatic battery cans are used in vehicles due to their high energy density and efficient space utilization. However, the process of disassembling these battery cans for recycling or analysis presents significant challenges. Currently, tear down methods for prismatic battery cans predominantly rely on motorized cutting fixtures. These fixtures are necessary to precisely cut through a metal casing without damaging the internal components. Tear down of the battery cans using these fixtures is time consuming and, thus, further development is needed.

### SUMMARY

In one configuration, an apparatus for cutting a prismatic battery cell can is provided and includes a base, a fixture coupled to the base for orienting the prismatic battery cell can and a cutting device. The cutting device includes one or more guide rails coupled to the base, a retainer coupled to the one or more guide rails and movable with respect to a first axis, a tool guide coupled to the base, and one or more cutting tools coupled to the retainer and to the tool guide, the one or more cutting tools being movable with respect to the first axis and a second axis that is perpendicular to the first axis.

The apparatus may include one or more of the following optional aspects. For example, the retainer can include an upper guide plate and a lower guide plate coupled to the upper guide plate. The retainer can include a slideway between the upper guide plate and the lower guide plate. A portion of the one or more cutting tools can be arranged in the slideway between the upper guide plate and the lower guide plate.

According to one aspect, the one or more cutting tools can include a channel extending between a first end and a second end. The one or more cutting tools can include a blade arranged in the channel between the first end and the second end. The one or more cutting tools can include a gib extending along the channel and positioning the blade. The gib can include a pressure plate and one or more set screws that engage the pressure plate and tighten the blade within the gib.

According to another aspect, the tool guide can include one or more slots extending between an upper end and the base. At least a portion of the one or more cutting tools can be arranged in the one or more slots.

In another configuration, an apparatus for cutting a prismatic battery cell can is provided and includes one or more guide rails, a retainer coupled to the one or more guide rails and movable with respect to a first axis, a first cutting tool coupled to the retainer and movable with respect to a second axis that is perpendicular to the first axis, a second cutting tool opposing the first cutting tool and coupled to the retainer, the second cutting tool being movable with respect to the second axis, a first guide including a first end and a second end spaced from the first end, the first guide having a first engagement surface that engages the first cutting tool and is tapered in a first direction from the first end to the second end, and a second guide including a first end and a second end spaced from the first end, the second guide having a second engagement surface that engages the second cutting tool and is tapered in a second direction from the first end to the second end.

The apparatus may include one or more of the following optional aspects. For example, the retainer can include an upper guide plate and a lower guide plate coupled to the upper guide plate. The retainer can include a slideway between the upper guide plate and the lower guide plate. A portion of the first cutting tool and the second cutting tool can be arranged in the slideway between the upper guide plate and the lower guide plate. The first cutting tool and the second cutting tool extend through and are movable along a passage that extends through the lower guide plate.

According to at least one aspect, the first engagement surface and the second engagement surface cause the first cutting tool and the second cutting tool to converge with respect to the second axis when the retainer moves with respect to the first axis.

According to at least one example, the first cutting tool and the second cutting tool can each include a channel extending between a first end and a second end of each cutting tool. The first cutting tool and the second cutting tool can each include a blade arranged in the channel between the first end and the second end of each cutting tool. The first cutting tool and the second cutting tool each can include a gib extending along the channel and positioning the blade. The gib can include a pressure plate and one or more set screws that engage the pressure plate and tighten the blade within the gib.

### BRIEF DESCRIPTION OF THE DRAWINGS

The drawings described herein are for illustrative purposes only of selected configurations and are not intended to limit the scope of the present disclosure.

FIG. 1 is a front perspective view of a vehicle including a power reservoir according to principles of the present disclosure;

FIG. 2 is a top perspective view of a prismatic can that can be used in the power reservoir of the vehicle of FIG. 1;

FIG. 3 is a side view of the prismatic can of FIG. 2;

FIG. 4 is an end view of the prismatic can of FIG. 2;

FIG. 5 is a partial exploded end view of the prismatic can of FIG. 2;

FIG. 6 is a front view of an apparatus in a first position according to the principles of the present disclosure;

FIG. 7 is a side view of the apparatus of FIG. 6;

FIG. 8A is a top cross-sectional view of a configuration of a cutting arm that can be used in the apparatus of FIG. 7;

FIG. 8B is a top cross-sectional view of another configuration of a cutting arm that can be used in the apparatus of FIG. 7; and

FIG. 9 is a side view of the apparatus of FIG. 6 in a second position.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

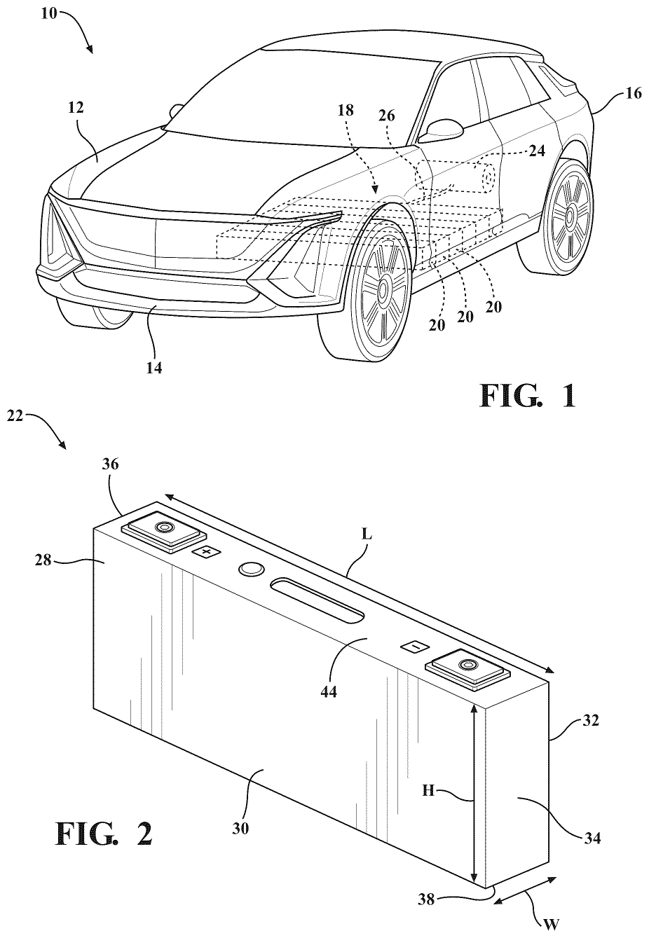

With reference to FIG. 1, an illustrative example of a vehicle 10 is provided. The vehicle 10 has a vehicle body 12 extending between a first end 14 and a second end 16. The vehicle 10 includes a power reservoir (e.g., battery pack) 18 coupled to the vehicle body 12 and has one or more battery modules 20. Each battery module 20 includes one or more battery cells 22 (FIG. 2) communicatively coupled to one another. The power reservoir 18 is communicatively coupled to an electric motor 24 that is coupled to the vehicle body 12 via a cable 26.

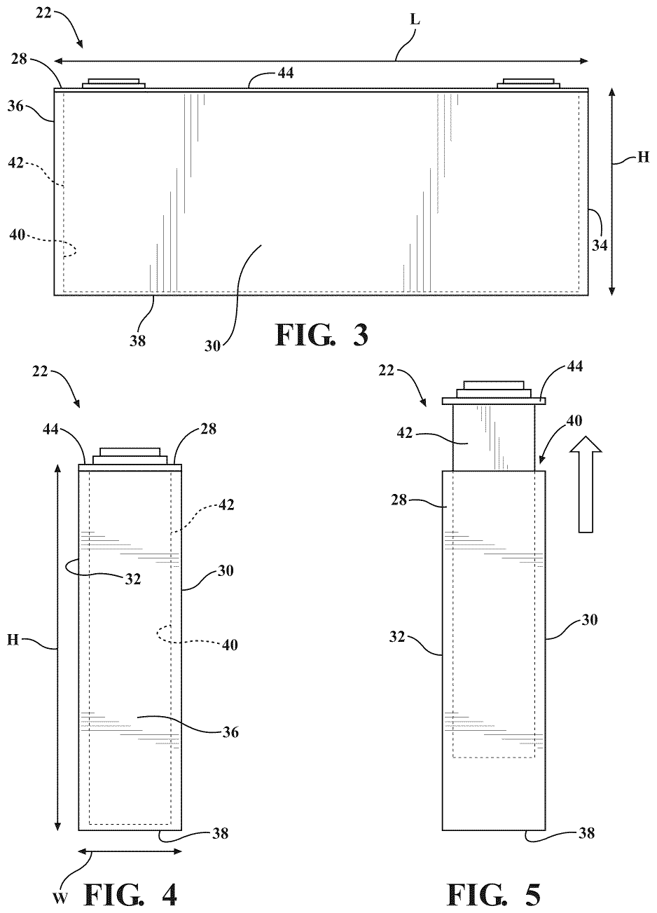

With reference to FIGS. 2-5, an illustrative example of one of the battery cells 22 is provided. The battery cell 22 includes a prismatic can 28 that can be formed from a metallic material such as aluminum or steel. The prismatic can 28 includes a width W arranged between a first side 30 and a second side 32 spaced from the first side 30 and length L arranged between a first end 34 and a second end 36 spaced from the first end 34. A bottom side 38 extends between the first side 30, the second side 32, the first end 34, and the second end 36 and forms a chamber 40 that is configured to receive and house battery internals 42. The prismatic can 28 includes a height H arranged between the bottom side 38 and a top side or lid 44 that is spaced from the bottom side 38. The lid 44 extends between and is coupled to or otherwise attached to the first side 30, the second side 32, the first end 34, and the second end 36 via welding or another method commonly used in the automotive industry. In at least some implementations, the lid 44 can be assembled with the battery internals 42 prior to being attached or otherwise coupled to the rest of the prismatic can 28.

With reference to FIG. 5, the prismatic can 28 may need to be cut open after assembly or operation for testing, recycling, or another purpose. Some of the existing methods for doing so are time consuming or can destroy portions of the prismatic can and/or battery internals. According to at least some aspects of the present disclosure, an apparatus 100 is provided and is configured to cut one or more portions of the prismatic can 28 or another type of battery cell used in the automotive industry.

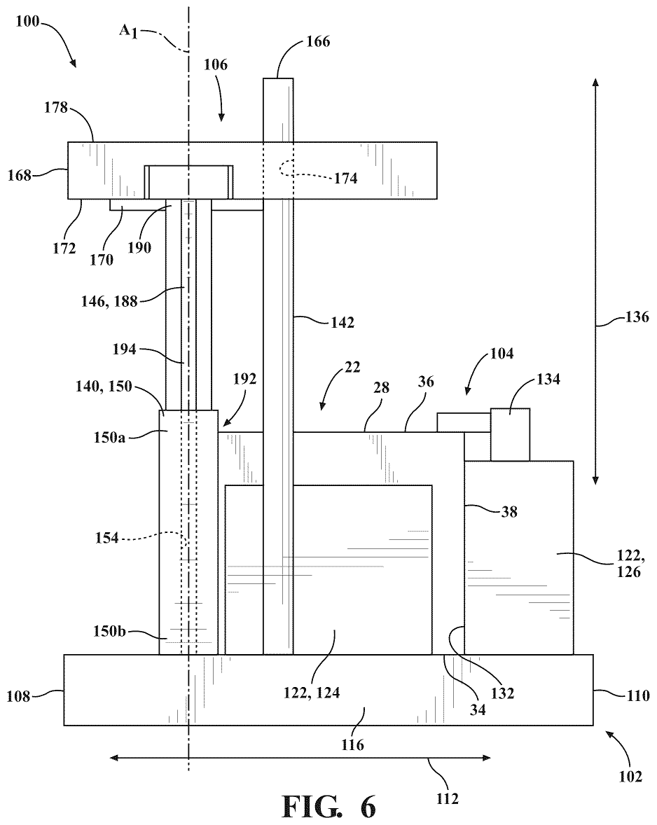

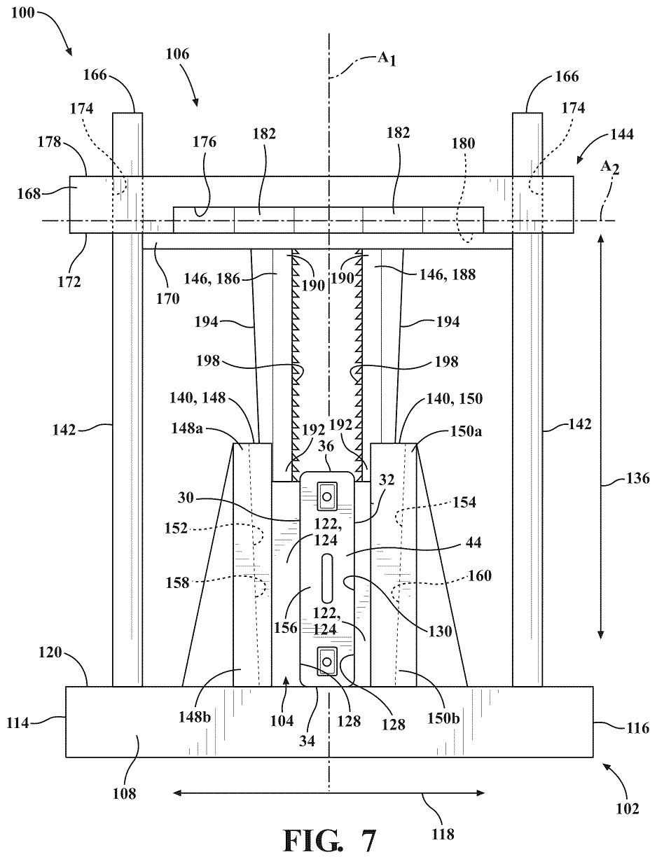

With reference to FIGS. 6 and 7, the apparatus 100 includes a base 102, a fixture 104, and a cutting device 106. The apparatus 100 and, more particularly, the base 102 can include or more through holes (not shown) so that the base 102 can be secured to a workbench, a floor, or another suitable surface. The base 102 includes a first end 108 and a second end 110 spaced from the first end 108 with respect to a longitudinal direction 112 and a first side 114 and a second side 116 spaced from the first side 114 with respect to a lateral direction 118. The fixture 104 and the cutting device 106 can be coupled to or otherwise attached to a top surface 120 of the base 102.

With continued reference to FIGS. 6 and 7, the fixture 104 includes one or more supports 122 that are coupled to the base 102 and configured to orient and/or restrain one of the battery cells 22. In general, the fixture 104 can be stationary and configured to receive one of the battery cells 22 so that the cutting device 106 can actuate and cut through a portion of the prismatic can 28 with respect to one of the length L, the width W, or the height H. Alternatively, the fixture 104 can be adjustable so that the fixture 104 can receive one of the battery cells 22 in more than one orientation. In other words, the fixture 104 can restrain the battery cells 22 in a first position so that the cutting device 106 can cut along one of the length L, the width W, and the height H and then can be adjusted by an operator or machine to a second position so that the cutting device 106 can cut along another of the length L, the width W, and the height H.

The supports 122 can include one or more side supports 124 and one or more end supports 126 that are coupled to the base 102. The side supports 124 each include inner surfaces 128 that are spaced from one another with respect to the lateral direction 118. In the present illustrative example, one of the side supports 124 is arranged adjacent to the first side 114 of the base 102 and another one of the side supports 124 is arranged adjacent to the second side 116 of the base 102. The inner surfaces 128 define a portion of a receptacle 130 and also engage with and confine the battery cell 22 with respect to the lateral direction 118. The one or more end supports 126 can be arranged between the side supports 124 and the second end 110 of the base 102, for example. The one or more end supports 126 each include an inner surface 132 that define a portion of the receptacle 130, as shown in FIGS. 6 and 7. The one or more end supports 126 prevent one of the battery cells 22 from moving along the base 102 with respect to the longitudinal direction 112. Optionally, the fixture 104 can include one or more anti-lift stops 134 coupled to the one or more side supports 124 and/or the one or more end supports 126 to help prevent the battery cell 22 from moving along a vertical direction 136 that is perpendicular to the longitudinal and lateral directions 112, 118. In practice, the battery cell 22 can be inserted into the receptacle 130 of the supports 122 with respect to the longitudinal direction 112 (i.e., from the first end 108 of the base 102 toward the second end 110 of the base 102).

With reference to FIGS. 6-10, the cutting device 106 can include one or more tool guides 140, one or more guide rails 142, a retainer 144 coupled to the one or more guide rails 142, and one or more cutting tools 146 coupled to and extending from the retainer 144.

With reference to FIGS. 6 and 7, the tool guides 140 are coupled to the base 102 and can be arranged between the first end 108 of the base 102 and the fixture 104 with respect to the longitudinal direction 112. In general, the tool guides 140 are configured to guide and/or engage with the cutting tools 146 to help facilitate cutting through one or more portions of the prismatic can 28. In the present illustrative example, the one or more tool guides 140 include a first tool guide 148 and a second tool guide 150. The first tool guide 148 has an upper end 148a and a lower end 148b that engages the top surface 120 of the base 102. Likewise, the second tool guide 150 has an upper end 150a and a lower end 150b that engages the top surface 120 of the base 102. The first tool guide 148 includes a first slot 152 extending between the upper end 148a and the lower end 148b and the second tool guide 150 includes a second slot 154 extending between the upper end 150a and the lower end 150b. The first slot 152 and the second slot 154 open toward a cutting zone 156 that is arranged laterally between the first tool guide 148 and the second tool guide 150. The first slot 152 includes a first engagement surface 158 that tapers in a direction from the lower end 148b to the upper end 148a and the second slot 154 includes a second engagement surface 160 that tapers in a direction from the lower end 150b to the upper end 150a. The taper of the first engagement surface 158 and the second engagement surface 160 is configured to control the cutting device 106 and, more particularly, a depth of a cut resulting from a cutting process discussed in more detail below.

The guide rails 142 are coupled to the base 102 and extend away from the top surface 120 to upper ends 166. In the present example, the guide rails 142 are parallel to each other and are configured to facilitate movement of the retainer 144 and/or the cutting tools 146 with respect to a first axis A1.

The retainer 144 can be arranged on and with respect to the guide rails 142 and driven manually, mechanically, or otherwise along the first axis A1. In other words, a force F can be applied by a mechanical press, a pneumatic machine, or another device commonly used in the automotive industry. In the present illustrative example, the retainer 144 includes an upper guide plate 168 and a lower guide plate 170 coupled to a bottom side 172 of the upper guide plate 168. The upper guide plate 168 includes one or more through holes 174 that extend through a thickness of the upper guide plate 168 and correspond with the guide rails 142. The upper guide plate 168 also includes a slideway 176 extending from the bottom side 172 toward a top side 178 of the upper guide plate 168. A portion of the cutting tools 146 can be arranged in the slideway 176 and secured between the upper guide plate 168 and the lower guide plate 170. The lower guide plate 170 can include a passage 180 that allows the cutting tools 146 to move in the slideway 176 and with respect to a second axis A2 that is perpendicular to the first axis A1. In at least some implementations, the cutting tools 146 can be coupled to bearings 182 that are movable within the slideway 176 and with respect to the passage 180.

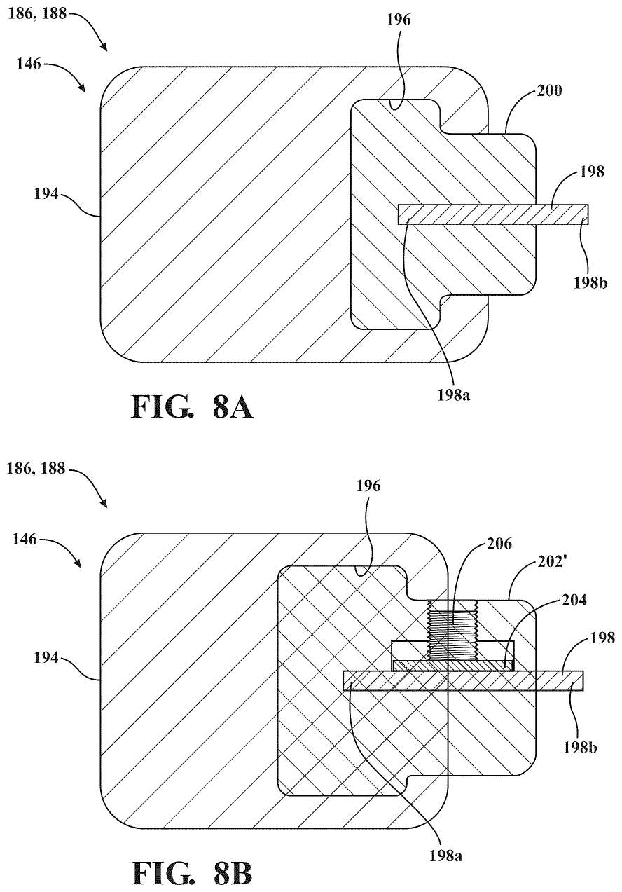

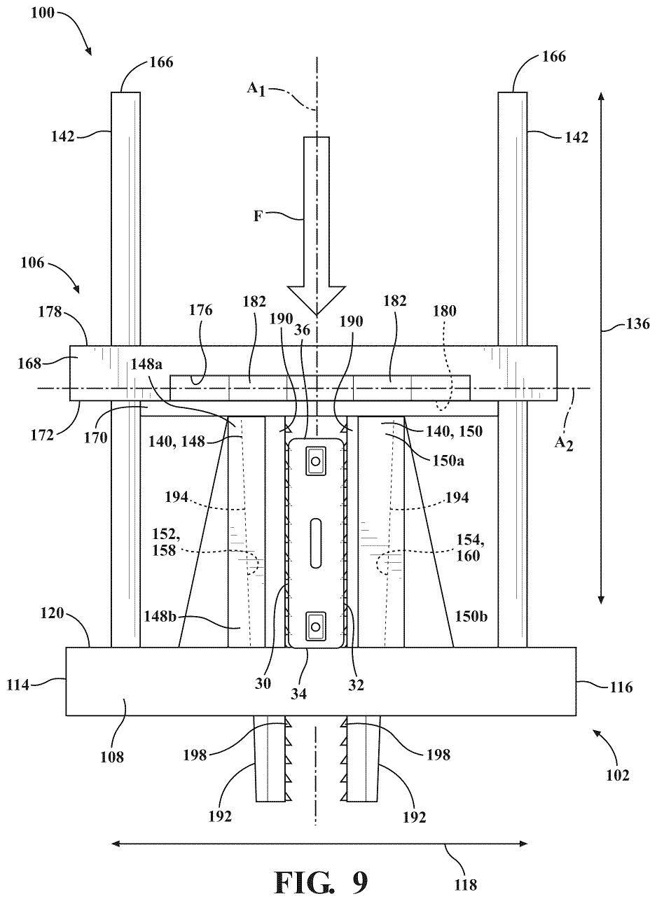

The cutting tools 146 can include a first cutting tool 186 and a second cutting tool 188 that are coupled to and extend between the retainer 144 and the tool guides 140. The first cutting tool 186 and the second cutting tool 188 each include a first end 190 and a second end 192 spaced from the first end 190. With reference to FIG. 8A, the first cutting tool 186 includes an engagement wall 194 extending between the first end 190 end and the second end 192 and configured to engage with the first engagement surface 158 or the second engagement surface 160. In other words, with reference to FIG. 9, when the retainer 144 and/or the cutting tools 146 are driven toward the base 102 with respect to the first axis A1, the first engagement surface 158 and the second engagement surface 160 of the tool guides 140 will act on the engagement walls 194 of the first and second cutting tools 186, 188 and cause the first and second cutting tools 186, 188 to converge with respect to the second axis A2.

With reference to FIGS. 8A and 8B, the first and second cutting tools 186, 188 include a channel 196 that extends between the first end 190 and the second end 192. The first and second cutting tools 186, 188 can be arranged in the retainer 144 so that the channels 196 oppose each other and face the cutting zone 156. A blade 198 can be arranged in the channel 196 and extend between the first end 190 and the second end 192. The blade 198 has a first end 198a and a second end 198b spaced from the first end 198a. The second end 198b can be defined by one or more teeth, for example. In at least some implementations, with reference to FIG. 8A, a gib 200 can be arranged in the channel 196 and orient the blade 198 between the first end 190 and the second end 192. More specifically, the first end 198a can be disposed within a portion of the gib 202 and the second end 198b protrudes from the gib 202, as shown in FIG. 8A. In other implementations, with reference to FIG. 8B, a modular gib 202′ can be arranged in the channel 196 and include a pressure plate 204 that can be tuned to orient the blade 198. In other words, the modular gib 202′ can be configured to receive one or more set screws 206 that can help secure the blade 198 to the modular gib 202′.

In operation, an operator or machine (e.g., a robot) can arrange one of the battery cells 22 within the receptacle 130 of the fixture 104. In the present illustrative example, the bottom side 38 of the prismatic can 28 is in contact with the inner surface 132 of the one or more end supports 126, the first and second sides 30, 32 of the prismatic can 28 are engaged with the inner surfaces 128 of the one or more side supports 124, and the first end 34 of the prismatic can 28 is in contact with the top surface 120 of the base 102. According to at least one aspect, the prismatic can 28 is further secured in the receptacle 130 with the one or more anti-lift stops 134 that engage with the second end 36 of the prismatic can 28. In doing so, the lid 44 of the prismatic can 28 extends just beyond the cutting zone 156 with respect to the longitudinal direction 112. In other words, the prismatic can 28 is arranged in the receptacle 130 so that the blades 198 will contact the prismatic can 28 between the lid 44 and the bottom side 38. At this stage, an operator or machine can actuate the retainer 144 to drive the retainer 144 toward the base 102. The engagement walls 194 of the first and second cutting tools 186, 188 engage the first engagement surface 158 and the second engagement surface 160 causing the blades 198 to engage with the first and second sides 30, 32 of the prismatic can 28 and cut the prismatic can 28 along the length L.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. An apparatus for cutting a prismatic battery cell can, comprising:
a base;
a fixture coupled to the base for orienting the prismatic battery cell can; and
a cutting device, comprising:
one or more guide rails coupled to the base,
a retainer coupled to the one or more guide rails and movable with respect to a first axis,
a tool guide coupled to the base, and
one or more cutting tools coupled to the retainer and to the tool guide, the one or more cutting tools being movable with respect to the first axis and a second axis that is perpendicular to the first axis.

2. The apparatus of claim 1, wherein the retainer includes an upper guide plate and a lower guide plate coupled to the upper guide plate.

3. The apparatus of claim 2, wherein the retainer includes a slideway between the upper guide plate and the lower guide plate.

4. The apparatus of claim 3, wherein a portion of the one or more cutting tools is arranged in the slideway between the upper guide plate and the lower guide plate.

5. The apparatus of claim 1, wherein the one or more cutting tools include a channel extending between a first end and a second end.

6. The apparatus of claim 5, wherein the one or more cutting tools include a blade arranged in the channel between the first end and the second end.

7. The apparatus of claim 6, wherein the one or more cutting tools include a gib extending along the channel and positioning the blade.

8. The apparatus of claim 7, wherein the gib includes a pressure plate and one or more set screws that engage the pressure plate and tighten the blade within the gib.

9. The apparatus of claim 1, wherein the tool guide includes one or more slots extending between an upper end and the base.

10. The apparatus of claim 9, wherein at least a portion of the one or more cutting tools is arranged in and moves with respect to the one or more slots.

11. An apparatus for cutting a prismatic battery cell can, comprising:
one or more guide rails;
a retainer coupled to the one or more guide rails and movable with respect to a first axis;
a first cutting tool coupled to the retainer and movable with respect to a second axis that is perpendicular to the first axis;
a second cutting tool opposing the first cutting tool and coupled to the retainer, the second cutting tool being movable with respect to the second axis;
a first guide including a first end and a second end spaced from the first end, the first guide having a first engagement surface that engages the first cutting tool and is tapered in a first direction from the first end to the second end; and
a second guide including a first end and a second end spaced from the first end, the second guide having a second engagement surface that engages the second cutting tool and is tapered in a second direction from the first end to the second end.

12. The apparatus of claim 11, wherein the retainer includes an upper guide plate and a lower guide plate coupled to the upper guide plate.

13. The apparatus of claim 12, wherein the retainer includes a slideway between the upper guide plate and the lower guide plate.

14. The apparatus of claim 13, wherein a portion of the first cutting tool and the second cutting tool is arranged in the slideway between the upper guide plate and the lower guide plate.

15. The apparatus of claim 14, wherein the first cutting tool and the second cutting tool extend through and are movable along a passage that extends through the lower guide plate.

16. The apparatus of claim 11, wherein the first engagement surface and the second engagement surface cause the first cutting tool and the second cutting tool to converge with respect to the second axis when the retainer moves with respect to the first axis.

17. The apparatus of claim 11, wherein the first cutting tool and the second cutting tool each include a channel extending between a first end and a second end of each cutting tool.

18. The apparatus of claim 17, wherein the first cutting tool and the second cutting tool each include a blade arranged in the channel between the first end and the second end of each cutting tool.

19. The apparatus of claim 18, wherein the first cutting tool and the second cutting tool each include a gib extending along the channel and positioning the blade.

20. The apparatus of claim 19, wherein the gib includes a pressure plate and one or more set screws that engage the pressure plate and tighten the blade within the gib.
